(19) United States
(12) Patent Application Publication
(10) Pub. No.: US 2025/0174982 A1
(43) Pub. Date: May 29, 2025

(54) Temperature Triggered Alert Apparatus

(71) Applicant: Solar Security, llc, Cheyenne, WY (US)

(72) Inventors: William Frazier Miller, Cheyenne, WY (US); Conrad Elliot Miller, Castle Pines, CO (US)

(73) Assignee: Solar Security, llc, Cheyenne, WY (US)

(21) Appl. No.: 18/958,963

(22) Filed: Nov. 25, 2024

Related U.S. Application Data
(60) Provisional application No. 63/602,654, filed on Nov. 26, 2023.

(51) Int. Cl. H02H 7/18; A62C 3/16; G01J 5/10; G08B 21/18; H04N 7/18; H04N 23/23

(52) U.S. Cl. CPC H02H 7/18; A62C 3/16; G01J 5/10; G08B 21/182; H04N 7/183; H04N 23/23

(57) ABSTRACT

Overheating of battery banks and other thermally dependent systems, and fires that may result therefrom, have plagued certain industries, e.g., the continually growing industry of renewable energy such as solar and wind power generation, for decades. Disclosed herein, inter alia, are apparatus and methods that may seek to prevent such fires by providing, e.g., continuous thermally dependent system temperature monitoring; alert system in the event of an abnormal temperature condition; and autonomous power shut-off componentry configured to shut-off thermally dependent system power without additional action by system operator(s). Other features, e.g., individual-initiated power shut-off over-ride, may enhance operational control, apparatus functionality or apparatus suitability for application to a single or multiple thermally dependent systems.

This US Non-Provisional patent application claims priority to and benefit of U.S. Provisional Patent App. No. 63/602,654, filed Nov. 26, 2023, said provisional patent application hereby incorporated herein in its entirety.

### BACKGROUND AND TECHNICAL FIELD

Battery banks, including but not limited to lithium-ion battery banks, have become increasingly common as communities/industries rely more on power sources that may require power storage, e.g., wind and solar power generation systems. However, such thermally dependent systems, such as lithium-ion battery banks, can ignite and cause a fire under certain operational conditions that can trigger a thermal runaway. Embodiments of the various inventive technologies disclosed herein, generally described as a temperature triggered alert apparatus that monitors thermally dependent systems such as but not limited to stored power systems, may seek to prevent such fires via a monitoring and power shut-off system that in certain manifestations may be autonomous, and an individual-initiated power shut-off over-ride.

### BRIEF DESCRIPTION OF THE FIGURES

FIG. 1A shows a schematic representation of a generalized field application of at least one embodiment of the inventive technology. FIG. 1B shows a schematic representation of a generalized field application of at least one embodiment of the inventive technology. Note that while the sensors shown are indicated as temperature sensors 2 (specifically, radiometric sensors 9), they may also just as easily more generally represent thermal sensors.

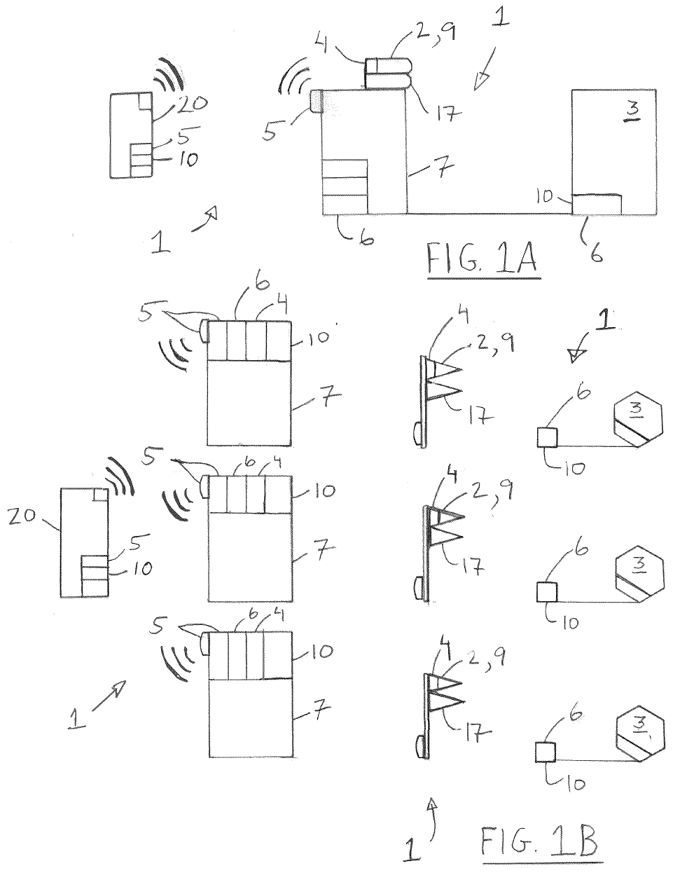

FIG. 2 shows a generalized schematic representation of an embodiment of the inventive technology, particularly with respect to power and communication between disparate aspects thereof.

FIG. 3 shows an overall layout of an embodiment of the inventive technology, more particularly showing a master and slave module, elevated radiometric camera, elevated video camera (fisheye enclosure and camera), and certain power componentry and communication cables (e.g., Cat5e cable).

FIG. 4 shows a master module (in environmentally sealed enclosure), with radiometric camera (camera with relay) and alert componentry (visual strobe and siren), with power shut-off over-ride componentry, inter alia, as may appear in certain embodiments of the inventive technology.

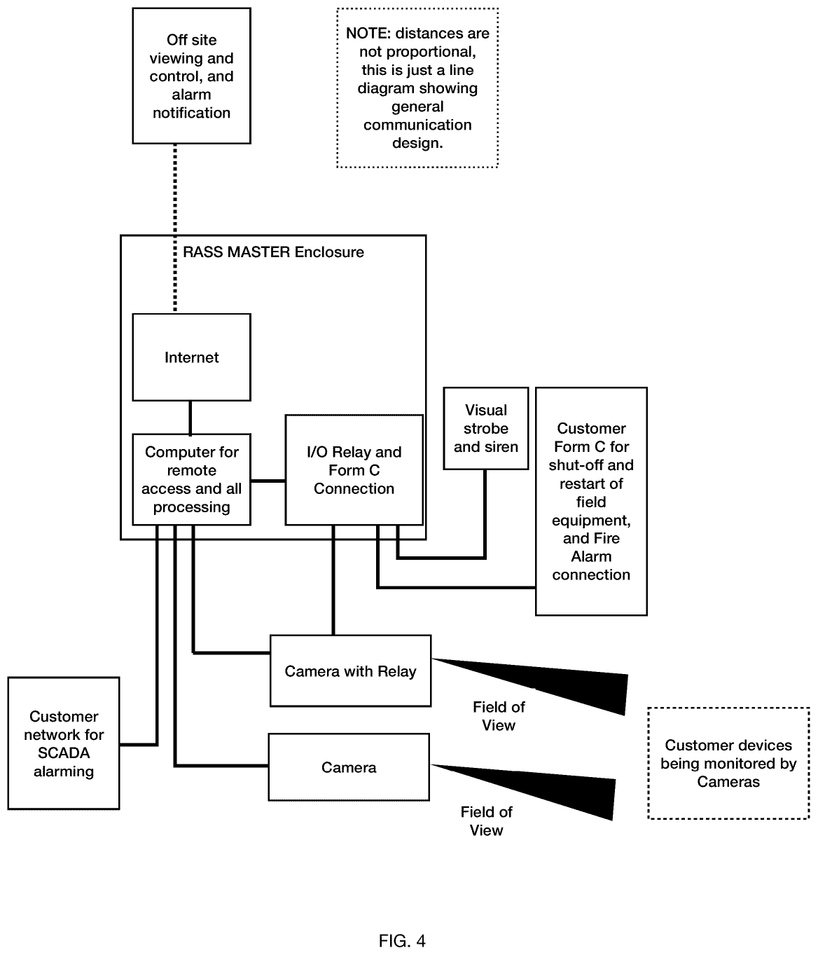

FIG. 5 shows enclosed componentry as may appear in at least one embodiment of the inventive technology.

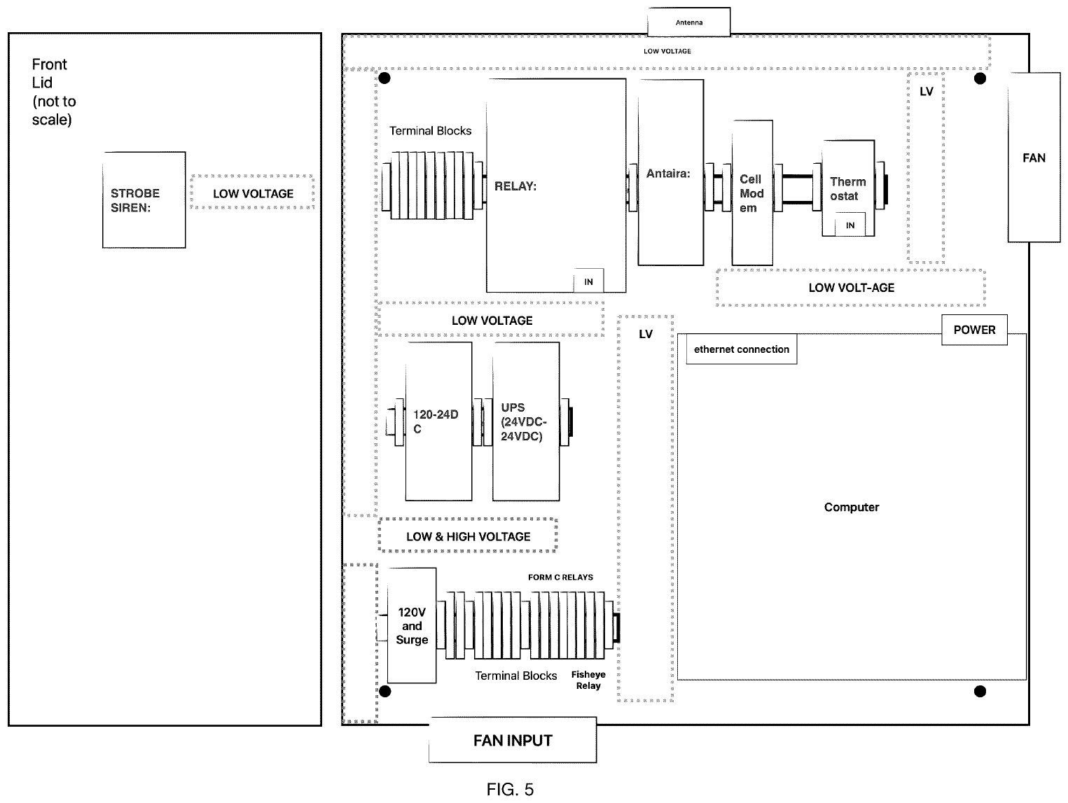

### SUMMARY OF THE INVENTION

Particular embodiments of the inventive technology may be described as a temperature triggered alert apparatus that features at least some of the following: a temperature sensor configured to generate sensed temperatures of a thermally dependent system such as a battery bank; a processor configured to detect the presence of an abnormal temperature condition (e.g., when a sensed temperature is higher than a reference thermally dependent system temperature); an alert system configured to alert at least one individual of the abnormal temperature condition; an autonomous power shut-off componentry configured to interrupt power to the thermally dependent system in the event of the abnormal temperature condition; and individual-initiated power shut-off over-ride componentry.

### DESCRIPTION OF PREFERRED EMBODIMENTS OF THE INVENTIVE TECHNOLOGY

The present invention may manifest in several embodiments and may exhibit different inventive facets. The description provided herein, while sufficiently enabling, may only explicitly describe certain of the several embodiments. Elements of the invention described herein can potentially be combined in various ways to create additional embodiments not explicitly described herein. Embodiments described herein may be exemplary only; they should not be read to limit the scope of the invention. Additionally, it should be understood that this application describes not only the multi-element apparatus and methods explicitly described, but also those involving any of the possible various combinations and permutations of such elements, and indeed perhaps even one element alone.

The inventive technology may be used to monitor what may be termed thermally dependent systems (system whose proper operation or function is, in some manner dependent on its temperature, or on the temperature of some componentry thereof). A thermally dependent system includes, e.g.: a system that is prone to damage not only from fire (fire damage prone system) caused by, e.g., overheating, but also to damage/malfunction caused by overheating without the occurrence of fire (e.g., certain power equipment); and system whose performance is negatively impacted by abnormal temperature condition, e.g., too low a temperature, too high a temperature, too high a rate of change of temperature, too low a rate of change of temperature, and/or failure to maintain a sufficiently constant temperature.

More particularly, thermally dependent system includes but is not limited to: equipment, power equipment, a landfill, compost pile, steel mill, refinery, distillery, waste processing, manufacturing, recycling center, battery storage system, fire-damage prone system (any system, including site, etc., that is prone to damage from fire), any device or site that a customer wants to be monitored for temperature triggered alerts, as but a few of many examples. In certain of such systems, it may be that there is no power (e.g., a landfill) supplied thereto or generated thereby, so there is no need to have power shutoff componentry; a temperature triggered alert may be generated by an alert system and may inform an individual(s) (human person(s)) of the fact of a abnormal (including performance impacting) temperature condition, and may even inform the individual(s) of the exact nature of the condition (e.g., “dangerously high temperature,” “too low temperature,” “too high rate of change of temperature,” etc.) and that individual(s) can then take action to prevent damage or further damage (e.g., by wetting a landfill or compost pile, moving the monitored system out of the sun, depowering the equipment, powering a heater configured to the equipment, powering AC to cool the equipment, all depending on the system and/or the nature of the temperature abnormality, etc.). But in certain of such systems, there may be a benefit for automated action without the need for any action by an individual; such automated action may include, e.g., autonomous power shutoff achieved by autonomous power shut off componentry (to prevent fire, additional damage, etc.), autonomous heater power (to increase temperature), autonomous wetting of a system, etc. (indeed, any desired mitigative act can potentially be automated). An alert generated in response to any of abnormal temperature condition may be referred to as a temperature-triggered alert.

The inventive technology, in particular embodiments, may be described as: a temperature triggered alert apparatus that includes, e.g., a temperature sensor (e.g., radiometric camera) configured to generate sensed temperatures of a thermally dependent system; a processor configured to detect the presence of an abnormal temperature condition (e.g., by comparing the sensed temperature to a reference thermally dependent system temperature, as but one logic-based step); and an alert system configured to alert at least one system operator of high temperature condition when sensed temperature(s), as perhaps analyzed by a processor, indicates an abnormal temperature condition.

The apparatus may further include (where, e.g., the thermally dependent system is powered) power shut-off componentry configured to interrupt power to and/or from the thermally dependent system in the event of an abnormal temperature condition. It may be autonomous, or individual-initiated (e.g., operator-initiated). Both types may include communication componentry configured to communicate an instruction to shut-off power of the thermally dependent system (whether that instruction is issued from, e.g., a processor or an individual). Of course, the apparatus may also include power componentry (e.g., power source and power cable(s)) to power the apparatus.

Certain embodiments may be articulated generally as a quickly deployable radiometric detection ecosystem, perhaps providing the customer with continuous radiometric monitoring of any abnormalities, visual verification of such abnormalities as signaled by an alert, and immediate, autonomous shut-off of customer devices and perhaps even autonomous alert provided to a fire department.

Embodiments of the inventive technology may be described as a temperature triggered alert apparatus 1 (where a temperature triggered alert may be triggered by the sensed presence of an abnormal temperature condition), and may feature, inter alia, componentry that can: autonomously shut-off the monitored system (e.g., thermally dependent system 3 such as, e.g., battery bank, including but not limited to lithium ion battery bank) when, e.g., a sensed temperature(s) of that system indicates an abnormal temperature condition; generate a sense-able alert via, e.g., high gain speaker, display, blue strobe light, and/or remote message-type alert, to notify an individual(s), e.g., site operators, on-site personnel and/or emergency personnel, of the presence of the triggering condition (e.g., high temperature of battery bank or other thermally dependent system); perhaps autonomous shut-off of power to/from the thermally dependent system; and perhaps user initiated shut-off over-ride componentry.

A temperature sensor, e.g., thermal camera, radiometric camera, as but a few examples) may generate sensed temperatures (or other indicators of fire or overheating) that a processor 4 can use to detect the presence of an abnormal temperature condition. A processor may be configured to detect the presence of an abnormal temperature condition based on at least one of the sensed temperatures. For example, the processor may be configured (e.g., programmed, designed, developed, etc.) to repeatedly compare a sensed temperature (e.g., as one, then the next, then the next, etc., of perhaps a continually generated series of real-time measurement) of a thermally dependent system with a reference thermally dependent system temperature. Note that a processor may be configured to detect the presence of an abnormal temperature condition based on sensed temperatures by comparing a determined sensed time rate of change of temperature (perhaps continually determined, repeatedly, based on newly acquired temperature data) to a reference rate of temperature (e.g., a maximum safe rate). A processor can be a subcomponent of a variety of other componentry, e.g., of the thermal sensor, radiometric camera, master or slave module (e.g., as housed in an enclosure perhaps referred to as a box), etc.

More particularly, an abnormal temperature condition may be indicated when, as but a few examples: a sensed temperature generated by a temperature sensor is higher and/or lower than, e.g., a (likely pre-determined) reference thermally dependent system temperature(s), which itself may be adjustable, e.g., operator-adjustable; a rate of change over time of a sensed temperature is above (or below) an acceptable rate of change (which also may be adjustable and/or pre-determined). For example, if it is determined that at or above a sensed, thermally dependent system temperature of 40° C., there may be a not-insignificant risk of fire, damage, destruction or malfunction, the system may be configured, whether by operator, factory setting or other, with a processor, via autonomous power shut-off componentry 6, to autonomously (e.g., without requiring human action) shut-off power to and/or from the thermally dependent system to prevent such fire, damage, etc. Autonomous functionality may also, as mentioned, include the communication of an alert (e.g., to an individual(s)) of the presence of the abnormal temperature condition.

Certain embodiments may alert individual(s) (e.g., a facility operator) of the high temperature condition and perhaps also that the thermally dependent system power has been shut-off, give them the option of shutting off thermally dependent system power themself(ves) (or take other mitigative action), perhaps via a simple instruction, or perhaps even provide a warning that power shut-off will occur shortly, allowing for alert over-ride by an alerted operator if he/she so chooses to prevent such shut-off (and/or terminate the alert).

Where power shut-off of the thermally dependent system (upon detection of an abnormal temperature condition) can occur autonomously, certain embodiments may offer individual-initiated (e.g., operator-initiated) power shut-off over-ride componentry that enables an operator, e.g., to easily, perhaps after doing investigation into the propriety of the alert and shut-down and concluding that it was improper (e.g., via remote viewing of a live camera feed and/or other data), power-up that shut down system; such action (i.e., power shut-off over-ride, and perhaps even investigation) can, in certain embodiments, be achieved by an individual remotely (remotely from the thermally dependent system and the thermally dependent system, i.e., off-site), e.g., from a control center, a smart phone, from a laptop, or generally from a computer, where such over-ride (power on, e.g., re-energization) instruction may be communicated to, e.g., on-site temperature triggered alert system componentry (on-site generally of the thermally dependent system) and/or the thermally dependent system, perhaps wirelessly and/or over wires. As such, the individual-initiated power shut-off over-ride componentry may be individual-initiated, remote power shut-off over-ride componentry.

The inventive temperature triggered alert apparatus, in particular embodiments, in order to promote its proper functioning and allow for intervention to prevent or promptly resolve malfunction, may also include componentry configured to monitor its own operational performance by monitoring (with, e.g., sensor(s), processor(s) and/or alert system(s)) one or more of its own parameter(s), e.g., enclosure internal temperature, enclosure internal humidity, state of power, functionality of componentry, etc. As such, in certain embodiments, where a sensed temperature of the temperature triggered alert apparatus itself (perhaps sensed by an internal temperature sensor such as a thermostat inside of an environmentally sealed enclosure 7 that houses at least some of the temperature triggered alert apparatus componentry) reaches a certain temperature at or above (or below) which the risk of monitoring system non-function or malfunction (or even damage) becomes unacceptably high, an alert may be provided, perhaps even alongside an autonomous response such as shut-off of the temperature triggered alert apparatus and/or increase in the degree/amount of cooling/heating of a temperature control system of the temperature triggered alert apparatus. Where there is provided componentry configured to monitor operational performance of the temperature triggered alert apparatus (including a sub-component(s) thereof), there may be provided a supplemental alert system that alerts an individual to the presence of a high temperature condition, malfunction, high humidity, etc., of the temperature triggered alert apparatus (including within any enclosure, or of any componentry). Alerts relative to operation of the temperature triggered alert apparatus may be any of the type indicated elsewhere herein.

Alert(s) may be provided by an alert system 5 in the case of abnormal temperature condition (e.g., too high a temperature, too low a temperature, too high rate of change of temperature, too low a rate of change of temperature, etc.) of the thermally dependent system, and/or even perhaps in the case of power shut-off/malfunction of such system and/or monitored system malfunction (as but a few examples). The alert system may include a variety of alerts such as but not limited to sense-able alert (i.e., which can be sensed by a human individual and/or possibly AI) such as local alert, remote alert, visual alert (e.g., light such as strobe, etc.), audible alert such as provided by a speaker (e.g., siren or some other audible notification, including a spoken message), alert to smart phone, remote message-type (e.g., smart (cell) phone alert), wirelessly communicated alert, computer device alert (e.g., message to cell phone or other computer device (e.g., remote system operation display), remote light or speaker with specific or more general alert and/or any type of sense-able notification.

Any alerts may be provided at the location of the temperature triggered alert apparatus, thermally dependent system, centralized operational control center, and/or at the location of an individual (via cell phone, e.g.) to whom the system is configured to send an alert (e.g., via text or other wirelessly communicated message, as but a few different examples). Alert(s) may be sent by alert communication componentry (part of the alert system) and received by, e.g., those in the area (e.g., light or audible alert that is sense-able (capable of being sensed) by on-site personnel) and/or those to whom the system is specifically configured to send a remote alert, e.g., message-type alert(s) (e.g., site operators, emergency services, individuals in a certain remote area where a remote speaker and/or light is established, etc., as but a few examples).

In certain embodiments, an alert may be specific as to the sensed condition triggering the alert (e.g., a speaker may announce (and/or text/display may read), e.g., “Battery shut-off due to high temperature”, “Excessively Low Temperature”, “Monitoring system non-function”, or a quick strobing may indicate battery shut-off, while a slower rate strobing may indicate monitoring system malfunction, as but a few examples.

In certain embodiments, when the presence of an abnormal temperature condition of the thermally dependent system is detected (e.g., a temperature that is too high), the processor (e.g., computer) of certain embodiments may autonomously cause, via an instruction, a power shut-off to and/or from the thermally dependent system, possibly by sending a signal (perhaps to a relay(s)) to interrupt power to and/or from the thermally dependent system (perhaps via a switch, established anywhere, e.g., in line with input power to the temperature dependent system or elsewhere). Certain embodiments may feature a latching relay so that after a triggering event such as abnormal temperature condition (e.g., sensed temperature is too high), the powering circuit to the thermally dependent system (e.g., from solar panels or wind turbine) will remain open even in the event of failure or malfunction of a system/apparatus, e.g. power failure to the temperature triggered alert apparatus' processor. Certain embodiments may feature, perhaps in addition to a relay, e.g., SCADA, TCP, MODBUS or DNP3 notifications/componentry. Note that the relay may be located in many different locations, e.g., be a part of the thermally dependent system.

As mentioned, certain embodiments may feature individual-initiated, remote power shut-off over-ride componentry 10 allowing, e.g., site operators to remotely control the monitoring system to, e.g., “accept” or identify an alert as false and to re-start the device being monitored, from a distance that is, e.g., not within reasonable walking distance to the temperature triggered alert apparatus that's on-site and the thermally dependent system. In certain embodiments, the inventive apparatus may be configured to offer an individual(s) (e.g., operator or owner) the ability to acknowledge an alert, and restart (for whatever reason) the field devices (e.g., power up thermally dependent system(s) and/or the temperature triggered alert apparatus themselves) that have been shut-off (perhaps autonomously). Such restarting may be done remotely in certain embodiments, e.g., from a centralized operational control center (which could even be simply a phone, laptop or other computer that is remote from the site of the thermally dependent system and from on-site componentry of the temperature triggered alert apparatus), perhaps located anywhere in the world. Certain control protocols provided by particular embodiments of the inventive technology may provide individual(s) (e.g., site operators) with the ability to initiate (e.g., manually (even, e.g., via a smart phone)) thermally dependent system power shut-off, without the autonomous analytics. In addition to such “manual” control, there may be provided the ability to alert other personnel.

The temperature triggered alert apparatus may be electrically powered, e.g., via a system that receives power (e.g., AC power) and perhaps transforms it as necessary via a transformer. Line or battery power is an option. Power, whether transformed or not, may be used to power, e.g., a DIN rail, cell modem, processor (e.g., computer), sensor(s), relay(s), heating element (e.g., heating plate), monitored system temperature sensor(s), camera(s), AC system, monitoring system thermostat, alert(s). In the inventive technologies various embodiments, one or more components may be powered via non-transformed power (e.g., 110V AC) and/or one or more components may be powered via transformed power. Power componentry may include, e.g., surge protector, circuit breaker, power transmission lines, DIN rail blocks, ground lug, power inlet(s), etc.

Certain embodiments of the inventive technology may utilize a temperature sensor, e.g., a thermal camera(s) such as a radiometric camera 9 or other known temperature sensor, that provides temperature data (e.g., radiometric measurements) of the monitored system temperature (thermally dependent system temperature) such as a battery bank temperature, where such camera is positioned within the sensing area/range of the temperature sensor. The thermal, e.g., radiometric camera, established on (e.g., outside of), near or perhaps even remotely from (but still within communication distance of) an enclosure that protects certain temperature triggered alert apparatus componentry. As mentioned, when used as a remote temperature sensor (remote from the thermally dependent system), the thermal camera may be placed any appropriate distance from the thermally dependent system (e.g., 15-20′, 300′, as but a few of many possible distances) as dependent on, at least, the operational range of the radiometric camera (and perhaps the size of the thermally dependent system, as but one possible additional factor). The temperature sensor, whether radiometric camera or other, may be established in any of a variety of positions relative to the remaining components of the temperature triggered alert apparatus-attached directly to an enclosure (box) that is distinct and remote from the thermally dependent system, established on a pole above the enclosure, on a pole separately from the enclosure, etc. Any visual cameras may be similarly established (e.g., on a dedicated pole, on a pole shared with a thermal sensor, on an enclosure).

Certain embodiments may feature a visual camera(s) 17, e.g., a fish-eye or other camera, that can provide live (and recorded) footage of cameras to provide a security view, e.g., a 360° security view of the thermally dependent system, and perhaps even the temperature triggered alert system. In embodiments featuring a visual camera, e.g., a fish-eye camera, such camera may facilitate intrusion detection, including a complete Avigilon analytics package, and/or provide situational awareness or meet other security-related need; a visual camera may allow an operator, whether, e.g., human or AI, to visually confirm the true state of any abnormal temperature condition for which an alert has been sent (e.g., to preclude a shut-off in the event of a false alert, or to confirm an alert as being proper or improper so as to use any shut-down over-ride componentry in the event of false alert and autonomous power shut-off). A visual camera may also allow for visual monitoring of apparatus while maintenance is being performed. But in certain embodiments, perhaps its most critical function is, as discussed, enabling, in certain applications, the assessment of the propriety of an alert (i.e., whether the alert was properly generated, due to an actual abnormal temperature condition).

The temperature triggered alert system may have substantially all, or at least critical components, sealed from the environment (often outdoors) in an environmentally sealed enclosure 7 that is outdoor rated and provides adequate protection against environmental factors (e.g., rain, snow, wind, etc.) to help preclude the entrance of environmental elements such as humidity and rain, thereby reducing the need for maintenance and reduce apparatus malfunction. At least some components of the temperature triggered alert apparatus may be completely contained environmentally so that it can operate in all weather and temperature conditions.

In certain embodiments, there may be provided temperature triggered alert apparatus temperature control componentry (e.g., cooling and/or heating componentry within the sealed enclosure) so that excessively hot and/or cold temperatures will not compromise the functionality of, nor damage, the monitoring system. A fan may be provided as a part of either or both of an AC or heating system so as to provide more effective and efficient cooling and/or heating and/or to mitigate the formation of excessively hot and/or cold portions within the sealed enclosure; the fan may help to equalize the temperature in the enclosure, thereby helping to avoid hot and cold extremes therein. Notably, certain componentry may, during typical use, generate heat, such as the computer. The heating and/or cooling system may be conventional in at least certain ways, e.g., a refrigerant type AC cooling system and a heating element (heating plate) heating system. Certain embodiments of the apparatus may feature temperature-hardened computers instead of or in addition to cooling and heating componentry. Certain embodiments of the self-contained unit(s), e.g., master box and slave box (the sealed enclosure(s) that may house at least some of the temperature triggered alert apparatus componentry) be without vents to the external environment.

A processor (e.g., any processing componentry, CPU, computer, software, hardware, etc.) may be provided in order to, e.g., compare sensed temperature(s) (any of a variety of temperature-dependent data of a monitored system such as a thermally dependent system, to a reference temperature condition (e.g., any of a variety of temperature-dependent data, including but not limited to a predetermined temperature value, including a temperature that is at the end of an allowable temperature range), and, perhaps in addition to autonomously issuing an alert, generate a shut-off instruction for communication (via communication componentry) to autonomous power shut-off componentry or component thereof (e.g., thermally dependent system power circuit opening componentry, e.g., a relay, e.g., any type of latching relay as but a few examples), perhaps located in the thermally dependent system, configured to open a power circuit of the thermally dependent system in the event of detection of an abnormal temperature condition. Communication componentry, which may be part of autonomous thermally dependent system power shut-off componentry, may communicate an instruction, e.g., shut off power, from a processor to autonomous power shut-off componentry; like other communication componentry, it may be wired or wireless. It is of note that even where a sensed temperature is typically in the form of a value.

A cell modem may, in certain embodiments, be established as part of the temperature triggered alert system and may provide for the transmission and/or receipt of information, including instruction; it may form part of any communication componentry. For example, it may enable the wireless communication of alerts, perhaps with messages, to remote computers, e.g., cell phones, system operation display, individual(s), etc. and/or may enable the receipt of control-related information (e.g., operator shutoff of the thermally dependent system, as but one of several control instructions). The modem and/or other known componentry may enable communication with the internet and/or provide control via one or more of the following: windows-based software, web browser, known wireless communication protocol(s), and/or a smart phone app, as but a few examples. Certain embodiments may feature remote control-related access that allows control of the temperature triggered alert apparatus, including sub-componentry thereof, from locations that are remote from the site of the thermally dependent system and/or sealed enclosure; such control may be facilitated by an internet connection, wireless command/instruction transmission componentry, other known componentry enabling remote control, etc. Remote control componentry may allow for de-powering (shut-off), and turn back on (re-power) of thermally dependent systems using, e.g., a relay and/or selected communication method. This may be done using proprietary integration of 3rd party components and software. Certain embodiments may allow for manual (user-selected) shut-off of customer components offsite anywhere in the world, using a computer or smart phone. Manual (individual-initiated) powering (turning on) of thermally dependent systems may be achieved via individual-initiated power shut-off over-ride componentry in the event of issuance of an improper alert, service was completed, fire/fire risk was abated/mitigated, or other reason.

Certain embodiments may feature componentry configured to enable monitoring of a plurality of thermally dependent systems. Indeed, certain apparatus may feature a multipoint system that itself features a plurality of thermally dependent systems (e.g., a plurality of battery banks) and one or more temperature triggered alert apparatus (e.g., one temperature triggered alert system for each monitored system, although it is possible that certain components are shared among such temperature triggered alert apparatus, but perhaps have a thermal camera for each monitored thermally dependent system). Inventive aspects may be that multipoint apparatus, and even the smaller, single point apparatus that make up that larger system. In certain embodiments, there may be one sealed enclosure housing certain temperature triggered alert apparatus componentry shared by several thermal cameras, each remote from a thermally dependent system which it is associated with and trained on.

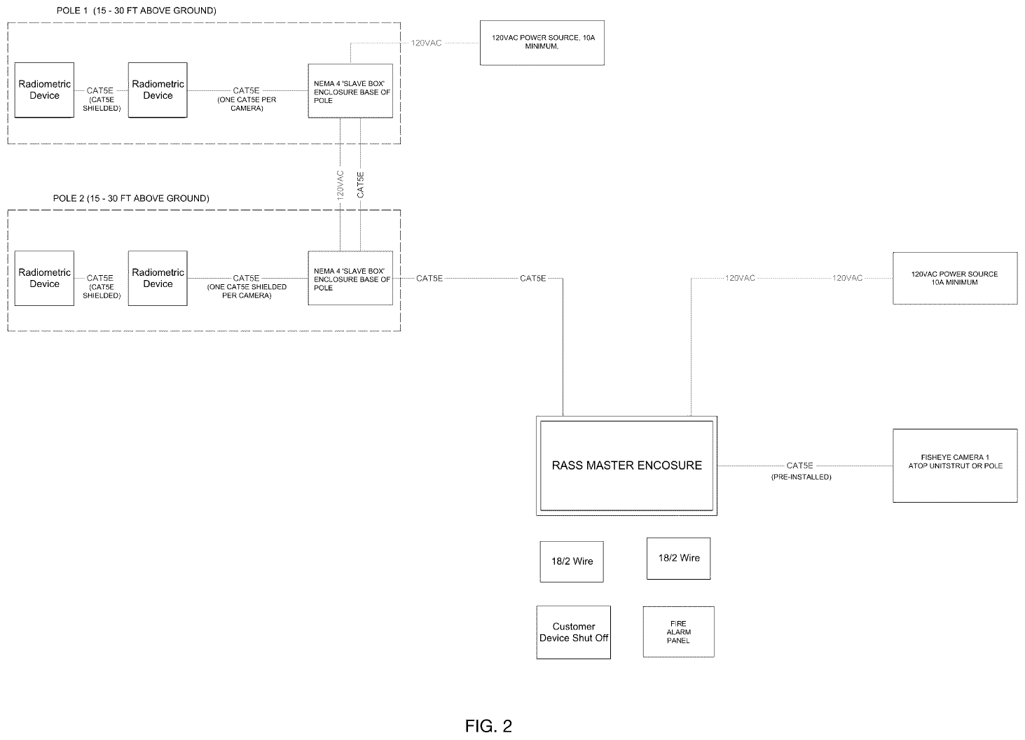

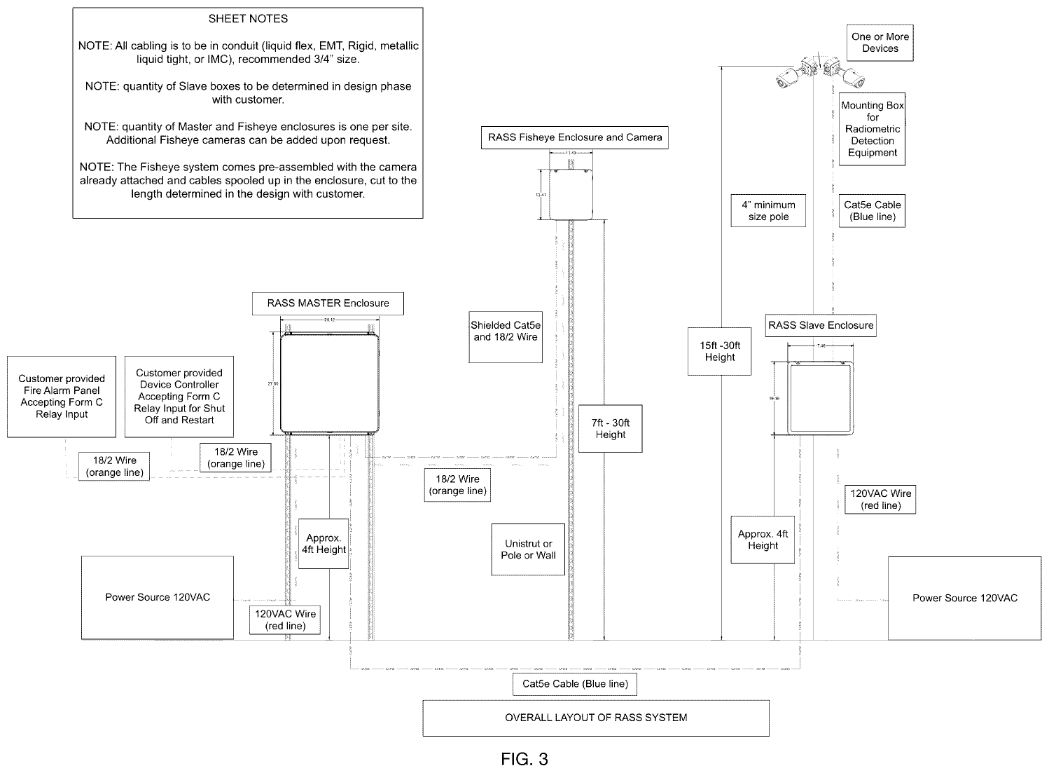

The system may be said to be scalable in that one or more temperature triggered alert apparatus and thermally dependent system pairing(s) can be linked with others in other locations, perhaps even throughout the world, perhaps through master and slave modules, such that perhaps a remote control center(s) 20 (which could even be a computer such as a smart phone in certain embodiments) can control all such linked pairings. Perhaps there can be more than one control center (e.g., each operated by a trusted individual); perhaps there is a single centralized control center. As shown in, e.g., FIGS. 2 and 3, certain embodiments may feature a master module (perhaps referred to as a box), each of which may provide some degree of control, power and/or communication relative to a plurality of slave modules, which may each include componentry (e.g., powering, communication and/or control) more directly associated with a thermal sensor(s) and perhaps a visual camera(s) as sufficient to monitor a thermally dependent system for abnormal temperature condition and assess propriety of detection of abnormal temperature condition and ensuing power shut-off. In particular embodiments, master boxes may be in communication with a control center(s). Note that a remote control center 20 can be used for temperature triggered alert apparatus that are used to monitor any number of thermally dependent systems (from 1 to many).

Of course, there may be power and/or communication componentry, whether wired or wireless, between certain componentry within or near a sealed enclosure of the temperature triggered alert apparatus and the thermally dependent system that such apparatus monitors (and perhaps shuts off as appropriate). Wired power lines may provide power from a power inlet to any power-consuming componentry (e.g., heating element, relay(s) (which, in certain embodiments, may be opened to interrupt power to thermally dependent system such as battery bank), alert(s), fan, cooling system, processor (e.g., computer), thermostat (which may control the heating plate), thermal and/or visual camera, sensor, cell modem, etc.). Data, perhaps communicated to certain componentry of the temperature triggered alert apparatus as one or more data entry(ies), may be communicated wireless and/or via data communication lines (e.g., data cables, fiber optic cables, coaxial cables, ethernet cables, twisted wire pair cables, etc.) as follows, by example and not by limitation: from a temperature sensor (e.g., thermal camera) to processor, e.g., onboard processing componentry; from the internal thermostat (internal of a sealed enclosure) to a processor and/or heating element; from a processor to, e.g., an alert system (perhaps including, e.g., speaker such as siren, etc., light, remote message, etc.); from a remote (off-site) individual to the processor and/or thermally dependent system, as relates to a control command such as power-on of such system; from, through or to the internet; from processors to power shut-off and/or shut-on componentry (e.g., to communicate a power shut-off or shut-on instruction to effect shut-off/-on of a thermally dependent system power), etc. Any communication componentry may include, e.g., transmitter and receiver (e.g., computer such as cell phone and/or other known componentry), wireless communication componentry, wires, cell phone, communication protocol componentry, communication hardware and/or software, cell phone app, etc. Of course, a cell phone or laptop (or other computer) could act as a transmitter with respect to certain communication (e.g., an individual-initiated power shut-off over-ride instruction), and a receiver with respect to a different communication (e.g., an alert of abnormal temperature condition).

Certain embodiments may feature plug-and-play 19 functionality and design to facilitate apparatus set-up, installation, modification, updating, expansion and/or scaling, e.g. Embodiments of the inventive technology may be described as an industrial grade, pre-assembled radiometric alerting ecosystem that may be shipped to site and that is configured for quick installation. In certain embodiments, componentry that achieves thermally dependent system power shut-off may be retrofittable onto existing thermally dependent system(s) to be monitored (and any enclosure and its components can be installed in sufficient proximity to a thermally dependent system to be monitored so as to allow thermal camera monitoring thereof). Certain plug-and-play componentry may be enterprise grade (using UL and cULus components) that should last the life of the site and be left indefinitely, and perhaps can be installed in one day using basic tools. Certain Plug N Play componentry is not tripod supported, securely installed and/or durable (exhibiting longevity). Embodiments of the inventive technology may feature, e.g.: componentry enabling an individual the ability to turn the thermally dependent system back ON if the individual wants to; “plug n play” componentry shipped to site for quick installation from −40 F-140 F temperatures; all weather capability; and/or fast assembly (e.g., onsite in 1 day with basic tools).

Certain embodiments of the inventive technology may be described as an intelligent and useful ecosystem (including, e.g., computer such as smart phone, laptop), that shows to an individual (e.g., customer) all thermally dependent systems (e.g., sites), and provides the individual complete control over turning off (depowering) any overheating systems, seeing alerts/fires, turning the systems back on (in the event of autonomous or individual-initiated power shut-off). Certain embodiments of the inventive technology may be described as a quickly deployed, high-end system, that is shipped and installed by their own technicians without any proprietary knowledge or tools. While certain embodiments might not feature battery backup, as customers can size the inventive apparatus to run on an external battery backup for owner equipment, certain embodiments may feature battery backup.

In certain embodiments there is provided the ability for a customer to view monitored systems (e.g., thermally dependent systems) and alerts anywhere in the world and respond; a fire department or other response personnel may also have live video access to the alerts in the inventive ecosystem. Embodiments of the inventive technology may provide live video of cameras, live video of a monitored thermally dependent system and/or enable confirmation of propriety of an alert (accurately determine if it is false or not), e.g., enable visual verification of propriety of an alert (look for smoke or fire, etc.). Embodiments of the inventive technology may provide the ability to view live alerts and live camera feeds.

Embodiments of the inventive technology may feature autonomous shut-off thermally dependent systems and/or manual (by operator) powering back on of an autonomously shut-down system. Embodiments of the inventive technology may feature durable componentry that affords a long term solution to monitoring and perhaps even fire prevention. Certain embodiments may be referred to as a radiometric alerting surveillance system.

Embodiments of the inventive technology may feature componentry that bypasses any SCADA or other network and goes straight to the device on/off switch, and won't be slowed down with issues regarding such network, network connectivity issues, etc. Certain embodiments of the inventive technology may feature independent internet access for remote operations, and perhaps independent from their SCADA network.

Installation of at least one embodiment of the inventive apparatus (e.g., as shown in FIG. 3) may involve the following steps:
1. RASS “Master” enclosure-Comes pre-assembled, ready to accept wires (relay wiring, ethernet cables, and power source).
2. Mount enclosure to wall, unistrut, or pole 4′ above ground. 65 lb weight.
3. Bring in cables, recommended ¾″ conduit (liquid tight, IMC, EMT, rigid, or metallic liquid tight), Use at least 3 separate conduits for power source, relay wires, and ethernet cables.
   a. Relay wiring (2):
      1. BESS shut off: run wire to customer provided BESS shut off, and terminate into RASS “Master” Form C terminal block.
      2. Fire Alarm Panel: run wire to customer provided Fire Alarm Panel and terminate into RASS “Master” Form C terminal block.
   b. Camera wiring: For any quantity of cameras, Cat5e shielded ethernet cables are used to communicate from “Slave” enclosures (at base of pole) to “Master” enclosure. Plug in ethernet at each enclosure's POE switch in any port.
   c. 120 VAC: 85-264 VAC/90-350 VDC power source (150 W draw for normal system design). Wire into “Master” breaker and terminal blocks (surge protection included in terminal blocks).
4. Fisheye
   a. Comes pre-assembled with camera attached and wire spooled up in fiberglass enclosure. Conduit not included.
   b. Mount enclosure to a wall, unistrut or pole 7-30′ above ground (determined by customer). 12 lbs weight.
   c. Bring in cables, recommended same conduit as rest of RASS system
      1. Fisheye: ethernet and 18/2 wire is provided by Solar Security for each job and sized for distance from Fisheye to Master
      2. Run ethernet cable into “Master” POE switch, plug into any port. Run 18/2 wire into dedicated Fisheye terminal block in “Master” enclosure.
5. Radiometric cameras
   a. Attach atop poles
   b. Fiberglass enclosure to be attached at the pole's base 4′ above ground
      1. 120 VAC: 85-264 VAC/90-350 VDC power source (30 W draw for normal system design). Wire into “Slave” breaker and terminal blocks (surge protection included in terminal blocks).
   c. Run conduit up the pole into Radiometric camera. Side holes in camera Jbox allow for conduit from camera to camera ethernet run. Each camera on the pole needs an ethernet cable
   d. Plug in ethernet cable into any port on “Slave” POE switch.

Certain embodiments may include generally a thermal sensor, which may include not only sensor(s) that generate temperature data (e.g., a radiometric camera), but also sensor(s) that do not generate sensed temperature(s), but instead generate at least one (non-temperature) sensed fire or near-fire indicator of a fire damage prone system (where near-fire refers to conditions where, without intervention such as power shut-off, material wetting, etc., there exists an unacceptably high risk of fire). A thermally triggered alert apparatus may include, e.g., a thermal sensor (smoke sensor, flame sensor, thermal image camera, radiometric camera, etc.) configured to generate at least one sensed fire or near-fire indicator of a fire damage prone system, where the data regarding the sensed fire indicator (e.g., presence of flame, high temperature) or near-fire indicator (presence of smoke, presence of certain combustion gases, high temperature) can be processed (e.g., analyzed) by the processor to detect (perhaps accurately or not) the presence of fire or near-fire condition. The apparatus may further include an alert system configured to alert at least one individual of said fire or near fire condition; autonomous power shut-off componentry configured to autonomously interrupt power to said fire damage prone system upon detection of the fire or near-fire condition; and individual-initiated power shut-off over-ride componentry. Particulars regarding such aspect of the inventive technology may be as indicated supra in this disclosure (for example, componentry may be contained in one or more environmentally sealed enclosure(s); apparatus may be plug-and-play, the apparatus may include at least one video camera trained on the fire prone system, etc.), where such disclosure is generalized/adjusted to, e.g., thermally triggered alert apparatus, sensed fire or near-fire indicator, fire damage prone system, fire or near fire condition as necessary.

Additional Information: Note that the terms element and componentry, where used in this disclosure, including its written description and figures, should be understood as referring to one component or structure, or more than one components or structures, whether physically connected or not. Further, this disclosure, where describing feature(s) of the invention in apparatus-oriented terminology, should be understood as also impliedly and inherently disclosing method or process steps relating to function(s) performed by such feature(s) either alone or in combination with other disclosed features, where such function(s) would be apparent to a person having ordinary skill in the art after reviewing this disclosure. Further, one specific componentry (or, e.g., element) can perform not just one, but also, in certain embodiments, two or more different functions or steps, and two or more different steps can even be performed simultaneously. With respect to any use of the term configured, it should be understood to imply, e.g., connected, assembled, installed, oriented, set-up, established, designed, shaped, arranged, programmed, etc., as appropriate, that achieves the indicated function or result. With respect to the use of the term “processor”, such should be understood to include but not be limited to any computerized component, e.g., digital circuit and/or logic circuit, capable of carrying out instruction(s) and/or acting on data.

Relatedly, explicit disclosure of a noun should be understood as implicit disclosure of the verb performed by that noun, and vice versa (for example, explicit disclosure of a “sensor” effectively discloses, implicitly, “sensing”; explicit disclosure of “sensing” effectively discloses, implicitly, a “sensor.”) The figures in particular should be understood as impliedly and inherently disclosing relative positioning of features/componentry shown, where such relative positioning would be apparent to a person having ordinary skill in the art. Further, technical aspects of the invention that would be known to a person having ordinary skill in the art, having reviewed this disclosure, may not be described in explicit detail in the application as filed to avoid a tedious or prolix writeup. Accordingly, this disclosure should be understood as including such aspects, even where not explicitly disclosed.

This disclosure should be understood as providing a broad supporting description that supports even claims not explicitly appearing in the application as filed. For example, this application should be understood as providing support for the combination of any two or more features, components, parts, structures, or steps where such combination is not explicitly disclosed in the application as filed. Indeed, the application as filed is intended to provide support for any permutations and combinations of any two or more features, components, parts, structures, or steps explicitly disclosed therein. Individual aspects disclosed in the application as filed should be potentially considered as independent inventions even where they are not explicitly indicated as such. Even where only one specific embodiment is disclosed, whether in exemplary fashion or not, in explicit or unspecified support of a broad invention description or claim, such description or claim should not be limited in scope to such specific embodiment. The application as filed should also be understood as supporting products produced by explicitly disclosed processes or methods; and processes or methods that manufacture explicitly disclosed apparatus.

Where terms of approximate equality such as “substantially” (e.g., “substantially equal to [reference value]”) are used in this disclosure, it should be understood that such terms include values within a closed-ended range of 5% of the indicated reference value, centered on that reference value. For example, “substantially equal to 100° C.” would include from and including 97.5° C. to and including 102.5° C. Note that not all uses of the term “substantially” or “substantial” are subject to this definition, as not all such terms are used to suggest sameness in some manner.

Any figures filed as part of this disclosure seek to show the invention or aspects thereof clearly and in uncluttered fashion. Accordingly, it is not necessarily the case that each of the figures of this disclosure shows every single component of the inventive technology or the aspect that it seeks to portray. For example, certain componentry, e.g., certain wires/cables associated with power and communication componentry, might not be shown for simplicity. It is also not necessarily the case that every single component shown on a figure is called out in that figure with a label given to that component in the written description.

Further, to the extent any amendments, characterizations, or other assertions previously made (in or with respect to this or any related patent applications or patents, particularly in any parent, but also in any sibling or child application) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, particularly in any parent, but also in any sibling or child application, may need to be revisited. Accordingly, for example, if a broader claim or claim term is submitted in an application after an assertion (made in a different application) that prior art is different from a prior claim or claim term (of that different application), then, to the extent it might otherwise be construed as a disclaimer of subject matter, such assertion is rescinded and retracted (and such prior art may need to be revisited).

With respect to claims or description using the term “comprise” or variant forms thereof, the use of “a” or “an” in connection with a limitation (e.g., “a support member”), is to be interpreted as “at least one” unless context or description in the application indicates otherwise.

What is claimed is:

1. A temperature triggered alert apparatus, comprising:
a temperature sensor configured to generate sensed temperatures of a thermally dependent system;
a processor configured to detect the presence of an abnormal temperature condition based on at least one of said sensed temperatures;
an alert system configured to alert at least one individual of said abnormal temperature condition;
autonomous power shut-off componentry configured to autonomously interrupt power to said thermally dependent system upon detection of said abnormal temperature condition; and
individual-initiated, remote power shut-off over-ride componentry.

2. A temperature triggered alert apparatus as described in claim 1 further comprising at least one environmentally sealed enclosure in which at least some of said apparatus componentry is housed.

3. A temperature triggered alert apparatus as described in claim 1 wherein said temperature sensor comprises a radiometric camera.

4. A temperature triggered alert apparatus as described in claim 1 wherein said alert system comprises alert communication componentry configured to communicate said presence of said high temperature condition to at least one individual.

5. A temperature triggered alert apparatus as described in claim 4 wherein said alert communication componentry is configured to indicate reason for said power interruption to said at least one individual.

6. A temperature triggered alert apparatus as described in claim 1 wherein said autonomous power shut-off componentry comprises communication componentry configured to communicate a power shut-off instruction to thermally dependent system power circuit opening componentry.

7. A temperature triggered alert apparatus as described in claim 6 wherein said thermally dependent system power circuit opening componentry comprises a relay.

8. A temperature triggered alert apparatus as described in claim 1 wherein said thermally dependent system comprises a system selected from the group of equipment, power equipment, a landfill, compost pile, steel mill, refinery, distillery, waste processing, manufacturing, battery storage system, battery bank, lithium ion battery bank, and any device or region that a customer wants to be monitored for temperature triggered alerts.

9. A temperature triggered alert apparatus as described in claim 1 further comprising plug-and-play componentry.

10. A temperature triggered alert apparatus as described in claim 1 further comprising componentry configured to enable monitoring of a plurality of thermally dependent systems.

11. A temperature triggered alert apparatus as described in claim 1 further comprising componentry configured to enable remote control of a plurality of temperature triggered alert apparatus.

12. A temperature triggered alert apparatus as described in claim 1 further comprising at least one master module in communication with a plurality of slave modules.

13. A temperature triggered alert apparatus as described in claim 1 further comprising at least one video camera configured to provide a remotely viewable, live view of at least said thermally dependent system.

14. A temperature triggered alert apparatus as described in claim 1 further comprising at least one remote control center.

15. A thermally triggered alert apparatus, comprising:
a thermal sensor configured to generate at least one sensed fire or near-fire indicator of a fire damage prone system;
a processor configured to detect the presence of fire or near-fire condition based on at least one of said sensed fire or near-fire indicator;
an alert system configured to alert at least one individual of said fire or near fire condition;
autonomous power shut-off componentry configured to autonomously interrupt power to said fire damage prone system upon detection of said fire or near-fire condition; and
individual-initiated, remote power shut-off over-ride componentry.

16. A thermally triggered alert apparatus as described in claim 15 wherein said fire damage prone system comprises electrically or fuel powered equipment.

17. A thermally triggered alert apparatus as described in claim 15 further comprising at least one environmentally sealed enclosure in which at least some of said apparatus componentry is housed.

18. A thermally triggered alert apparatus as described in claim 15 wherein said autonomous power shut-off componentry comprises communication componentry configured to communicate a power shut-off instruction to thermally dependent system power circuit opening componentry.

19. A thermally triggered alert apparatus as described in claim 15 further comprising a remote control center configured to enable remote control of at least one temperature triggered alert apparatus.

20. A thermally triggered alert apparatus as described in claim 14 further comprising at least one video camera configured to provide a remotely viewable, live view of at least said thermally dependent system.
